(19) United States
(12) Patent Application Publication
(10) Pub. No.: US 2007/0013489 A1
(43) Pub. Date: Jan. 18, 2007

(54) System for automatic generation of a change schedule for a plurality of lighting means

(75) Inventors: Robert Bechtle, Falkensee (DE); Matthias Burczyk, Berlin (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/570,441

(22) PCT Filed: Aug. 25, 2004
(86) PCT No.: PCT/IB04/51559

§ 371 Date: Mar. 2, 2006

(30) Foreign Application Priority Data
Sep. 9, 2003 (EP) 03103333.5

(51) Int. Cl. G09F 25/00

(52) U.S. Cl. 340/286.01

(57) ABSTRACT

A system, a method and a computer program for planning the operation of a plurality of lighting means are described. For example in a department store, a number of different types of lighting means, e.g. filament lamps, discharge lamps and fluorescent tube lamps, may be installed. All of these lighting means have a certain life time and eventually need to be replaced. The system, method and computer program according to the invention automatically determine a change schedule with maintenance events for changing the lighting means, which leads to overall minimum cost in a specified time interval. The user enters a plurality of parameters for each groups of lighting means, including the number of lighting means in the group, type, price and/or value for a lifetime and operating time of the lighting means, as well as a first outlay parameter for preparation outlay and a second outlay parameter for changing outlay. The optimum change schedule is calculated in a way, where in case of identical change times for different groups, the first outlay parameter is accounted for only once.

The invention relates to a system, a method and a computer program for planning the operation of a plurality of lighting means.

In many installations, a large number of lighting means of different types are used at a common location, e.g. in the same building. For example in a department store, a number of different types of lighting means, e.g. filament lamps, discharge lamps and fluorescence tube lamps, may be installed. All of these lighting means have a certain lifetime and eventually need to be replaced.

On one hand, this can be done by exchanging single lighting means after they have broken down. The exchange of single lighting means in this way has a number of disadvantages, however. The outlay for changing a lighting means is considerable and comprises preparation outlay (e.g. time and work for retrieving exchange parts, time for service personal to reach the location, time for setting up a ladder or other devices) and actual changing outlay (work and time spend for changing the broken lamp).

It is possible to reduce the outlay by changing whole groups of lighting means, e.g. exchanging all lamps in one room after, say, 5% have failed. This method, however, also have some disadvantages. The current status of the lamps needs to be observed. The normal operation of the facility may be interrupted during the change. Especially, the costs involved cannot be planned.

US-A1-2002/0143421 discloses a data processing system used for performing predictive maintenance on an equipment, for example specified as mechanical equipment, electrical equipment, data processing system, electronics or optical equipment. The data processing system comprises a component database and a maintenance personal database. A scheduler schedules maintenance for components of the equipment. The schedule is based on the databases, elapsed time and a maintenance factor, which can be a financial estimate on maintenance of a component. The data processing system described may allow electronic commerce or business-to-business among the operator of the equipment and trading partners such as supplier of components or repair services.

While a data processing system as above described may generally allow an overview of necessary maintenance events and cost, there is still a need for a planning system and a method of operation specifically adapted to the operation of plurality of lighting means. It is therefore an object of the invention to propose a system, a method and a computer program for planning the operation of a plurality of lighting means, allowing most cost-efficient operation.

This object is achieved by a system according to claim 1, a method according to claim 9 and a computer program according to claim 10. Dependent claims are directed to preferred embodiments.

According to the invention, a system for automatic planning of the operation of a number of lighting means is provided with input and storage means for storing a plurality of parameters of the lighting means to be operated and computing means for calculating a change schedule for the lighting means.

The input and storage means are preferentially provided by a data processing system, comprising one or more digital computers. The input means can comprise devices connected directly to a computer, such as, for example, a keyboard, a mouse, touch-screen etc. Input means can also be provided over a network interface. Likewise, storage means can comprise any type of storage means known in connection with digital computers such as magnetic discs, random access memory, optical devices etc. Also, storage means can be provided over a computer network.

The system according to the invention accepts the input of a number of parameters describing the lighting means to be operated. The lighting means in one location are divided into a plurality of groups, where each group comprises lighting means of the same type. For each group parameters are stored indicating the number of lighting means in the group, type and/or price and life expectancy, and an operating time of the lighting means.

Further, a first and a second outlay parameter are stored. The first outlay parameter is representative of the outlay for preparation of a change of lighting means at the specified location, whereas the second outlay parameter is representative of the outlay for the actual changing of a lighting means. Further parameters may be used to provide more information about the lighting means.

The computing means use these parameters to calculate a change schedule for the lighting means. According to the invention, the change schedule is calculated such in a given time interval (optimization interval) the total cost for all groups are minimized. According to the invention, cost-effective operation can be achieved by simultaneously changing all of the lighting means of a group, and taking into consideration the cost for preparation for a change of lighting means at the specified location, where the preparation outlay will be the same, regardless whether the lighting means of just one, or of several groups are exchanged.

To achieve the latter, the computing means compute for each group the group costs for change and replacement of lighting means; and in case of identical change times for different groups account for the first outlay parameter, which represents outlay for preparation, only once. Therefore, in a cost-optimized change schedule, identical change times for different groups of lighting means will be provided in those cases, where the cost saved by preparing a change of lighting means at the location only once (e.g. cost/time for maintenance personal to arrive at the location, cost/time for transporting replacement lighting means to the location, cost/time for providing necessary equipment at the location) will exceed the additional cost incurred by exchanging lighting means before the actual life expectancy is reached, which ultimately may result in a higher number of changes within the optimization interval.

With the system, method and computer program according to the invention there is provided a means for an operator of a plurality of lighting means for efficiently planning operation of the lighting means, and scheduling exchange times to reduce cost to a minimum.

According to a development of the invention, database means are provided to store a number of lighting means types. For each type of lighting means, a number of parameters can be stored, e.g. a price and a value for an expected lifetime of the component. By employing such database means, parameter input into the system is facilitated for the user, because parameters like price and lifetime of a product can be looked up in the database rather than having to be provided by the operator. Up to date product information may be provided by the manufacturer of the lighting means.

In a major development of the invention, substitution means are provided for determining at least one alternative lighting means type for the present lighting means type of at least one of the groups. The alternative lighting means type will be able to replace the actual lighting means and thus have e.g. an identical socket and produce (within a tolerance), the same colour and a amount of light, but will differ in price, lifetime value and/or power consumption from the present lighting means type. During calculation of the change schedule, a possible exchange of lighting means types is evaluated. In case the exchange leads to an overall total of cost which is lower than without the exchange, the optimum change schedule calculated will comprise the exchange. This can be presented to the user in form of a proposal, indicating the cost that can be saved by the exchange.

While the above described substitution can already be beneficial if only lifetime and price of a lighting means are considered (because, for example, a different lighting means, although more expensive, may have a lifetime that fits better into the change schedule) further advantages arise if the cost of power consumption is additionally accounted for. Calculation of a cost optimum change schedule will reveal, e.g., whether the higher unit price for an energy saving lamp is justified for a certain group or not.

It is preferred that data storage means are provided for storing a number of projects. Each project comprises a plurality of groups of lighting means disposed at one location. Preferably, the system can be accessed by a number of persons, who can each manage one or more projects. The system can be made accessible over a computer network to receive inputs and direct outputs over the network. Most preferably, the system can be provided as a client/server application, where a server computer connected to a network provides the application for a number of clients also connected to the network.

According to a development of the invention, the calculated change schedule—usually after confirmation of the user—is stored. The system comprises messaging means, by which messages can be sent reminding of upcoming scheduled changes of lighting means. These messages can be sent a predetermined time in advance, so that it is possible to arrange for service personal and required material to be available at the scheduled time in the right location.

The computer program according to the invention allows planning of the operation of a plurality of lighting means. The computer program maybe stored on a magnetic or optical recording media. The program may be executable on a computer or a cluster of computers. It is preferred for the program to be adapted to a client/server structure, where the program itself runs on a server computer which may be accessed by clients, especially via a computer network.

For the user interface part of the program (input routine), it is preferred to use html or xml code. The storage routine for storage of parameters in a database and the computing routine for calculating change schedule may be provided in any computer executable form.

A preferred embodiment of the invention will be describe with reference to the attached drawings. In the drawings,

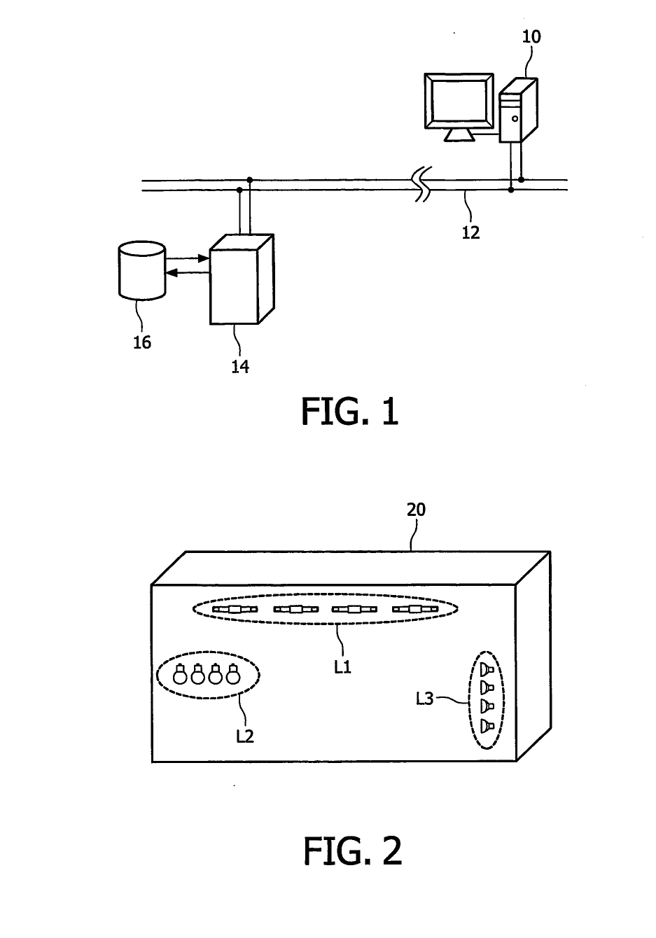

FIG. 1 shows a symbolic representation of a system for automatic planning of the operation of a number of lighting means;

FIG. 2 shows a symbolic representation of a facility with different lighting means;

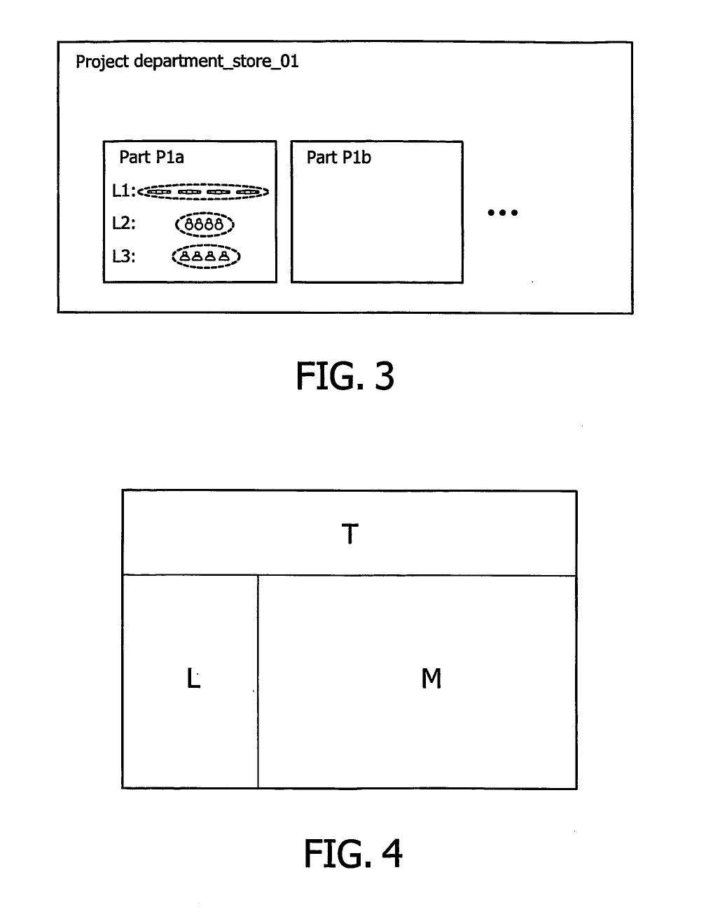

FIG. 3 shows a symbolic diagram of the structure of a project;

FIG. 4 shows the structure of a main frame;

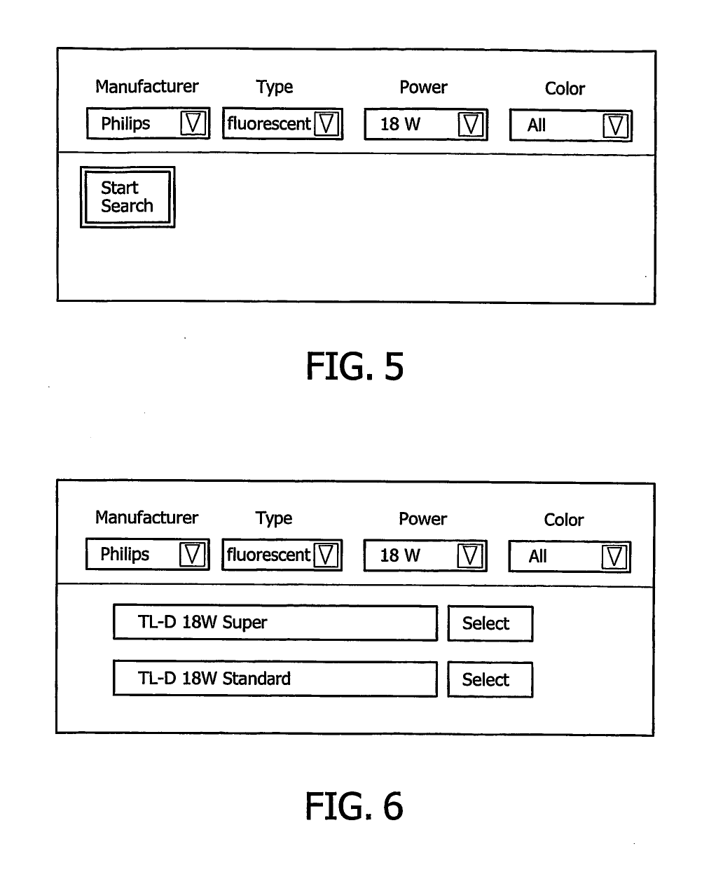

FIG. 5 shows a search page for searching a data base;

FIG. 6 shows a result page with data base search results;

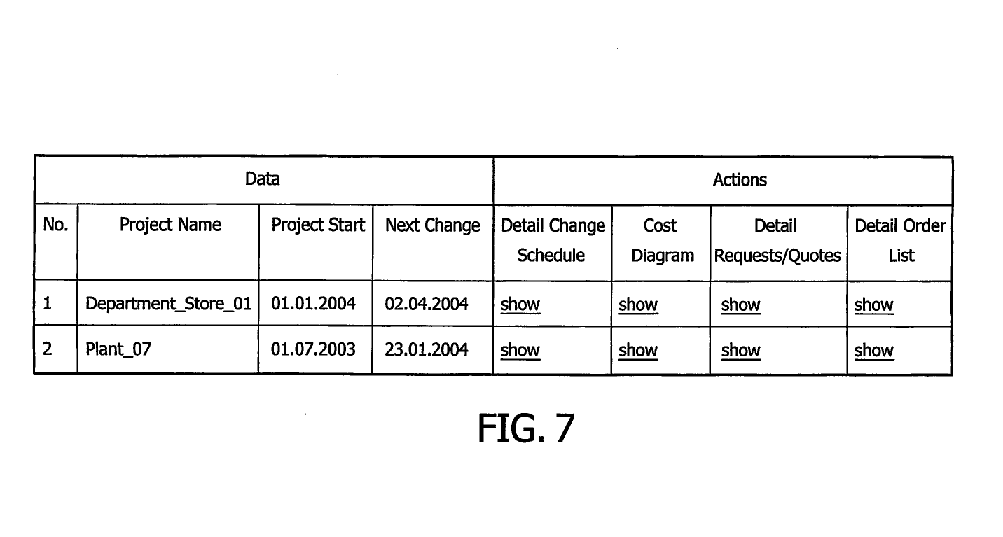

FIG. 7 shows a project overview table;

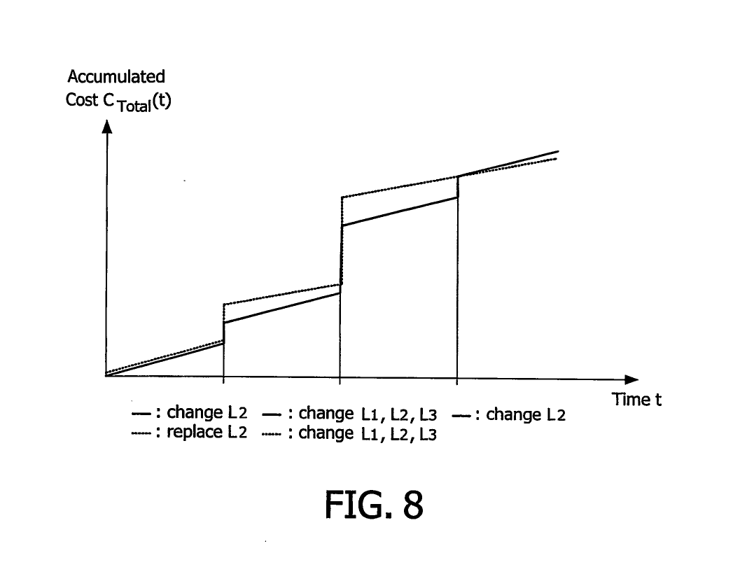

FIG. 8 shows two examples of a cost chart with accumulated total cost shown over time;

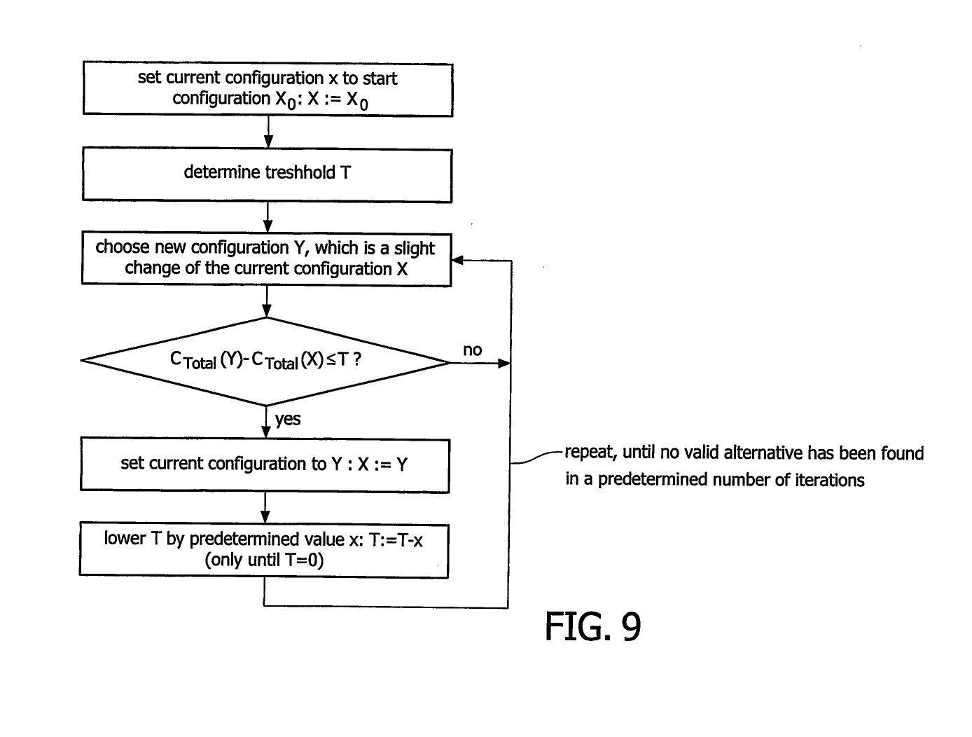

FIG. 9 shows a flow diagram of the “threshold accepting” optimisation method;

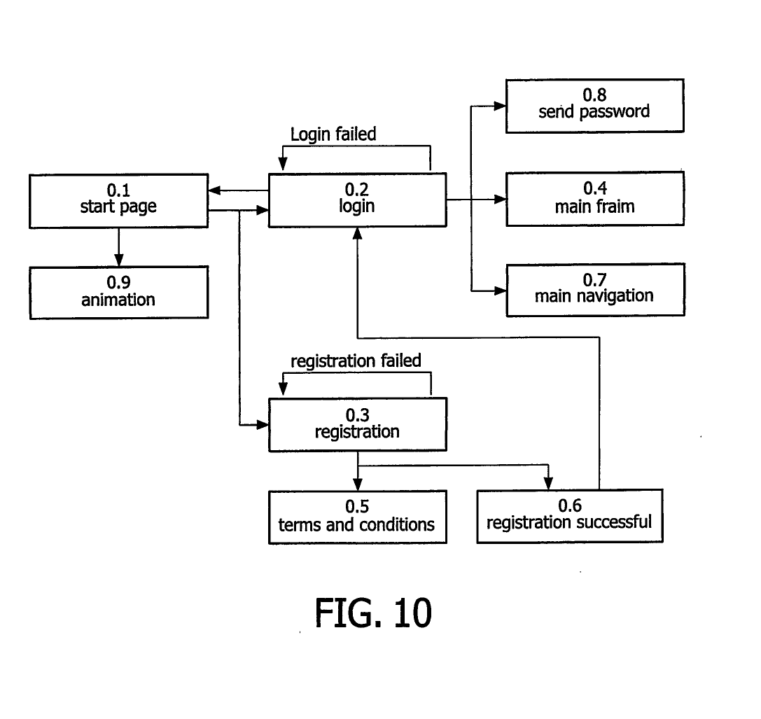

FIG. 10 shows a diagram of the structure of a login and registration module;

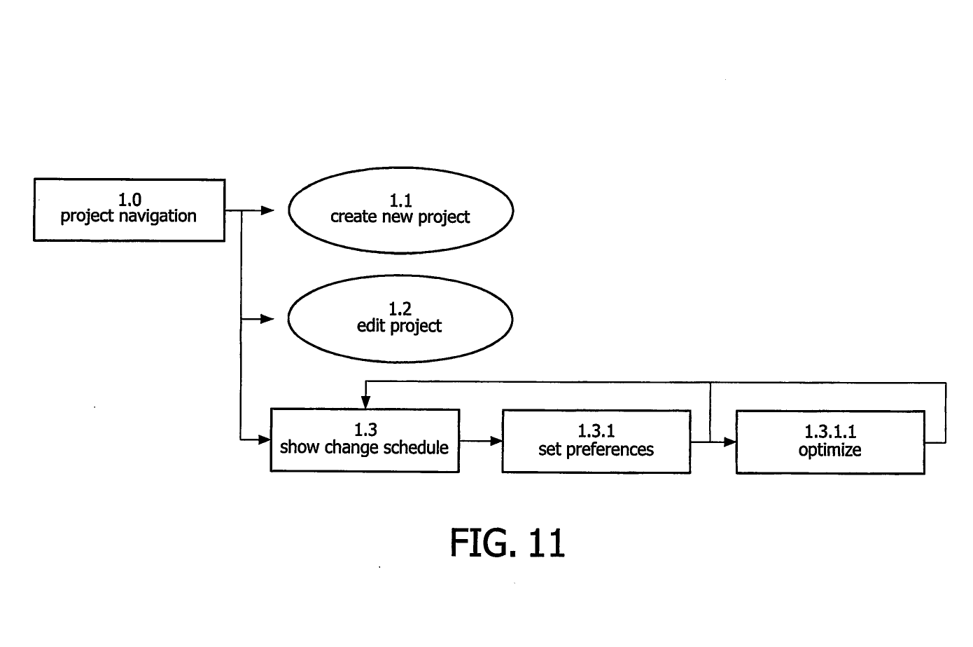

FIG. 11 shows a diagram with an overview over the structure of a project module;

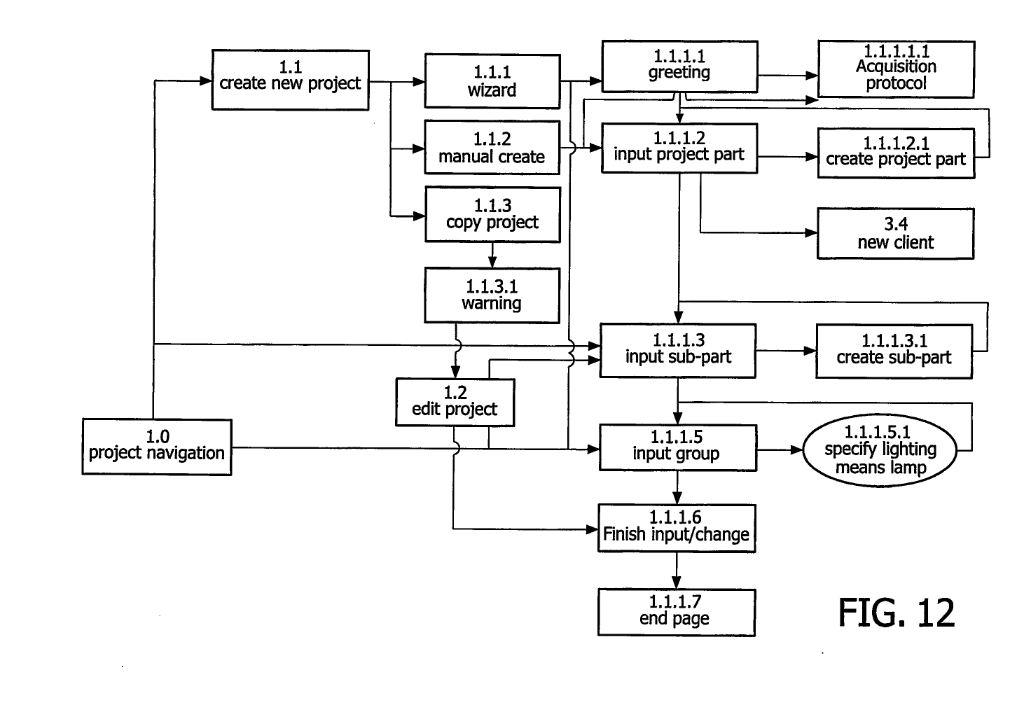

FIG. 12 shows a diagram with detail structure of a part of the module from FIG. 11;

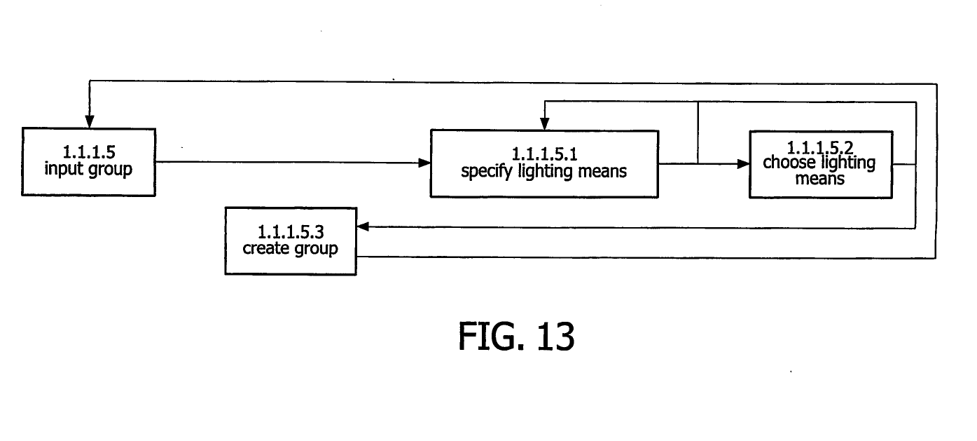

FIG. 13 shows the detail structure of a part of the module from FIG. 12;

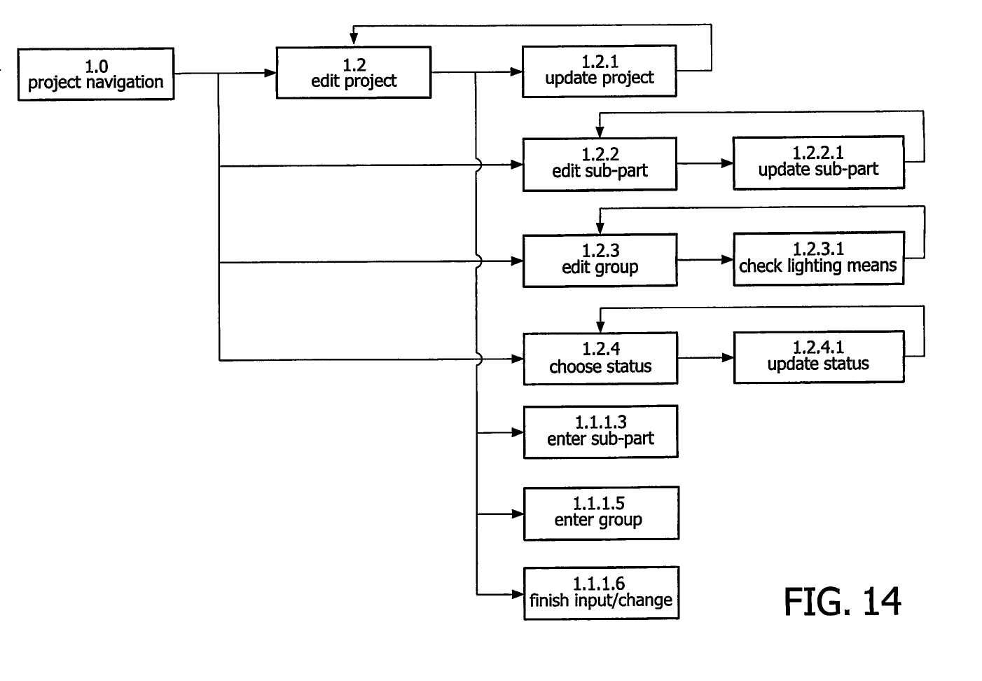

FIG. 14 shows a diagram with the detail structure of a part of the module from FIG. 11;

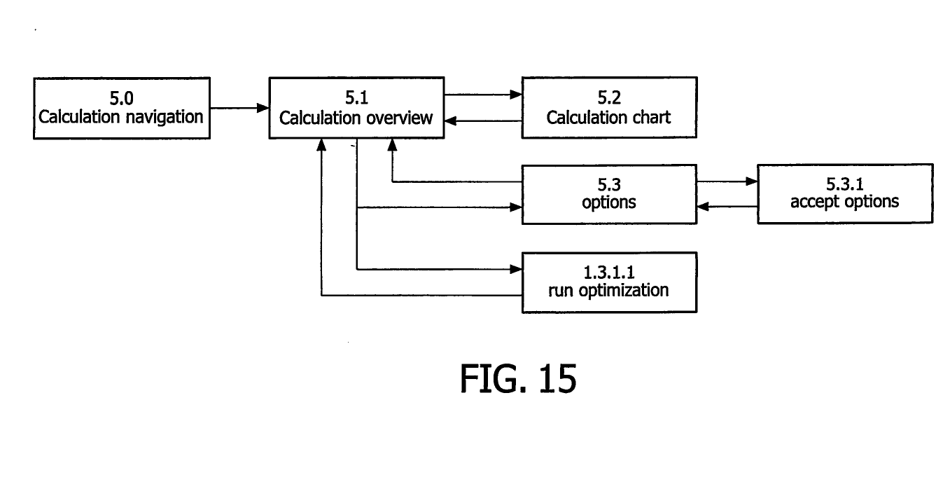

FIG. 15 shows a diagram with the structure of a calculation module;

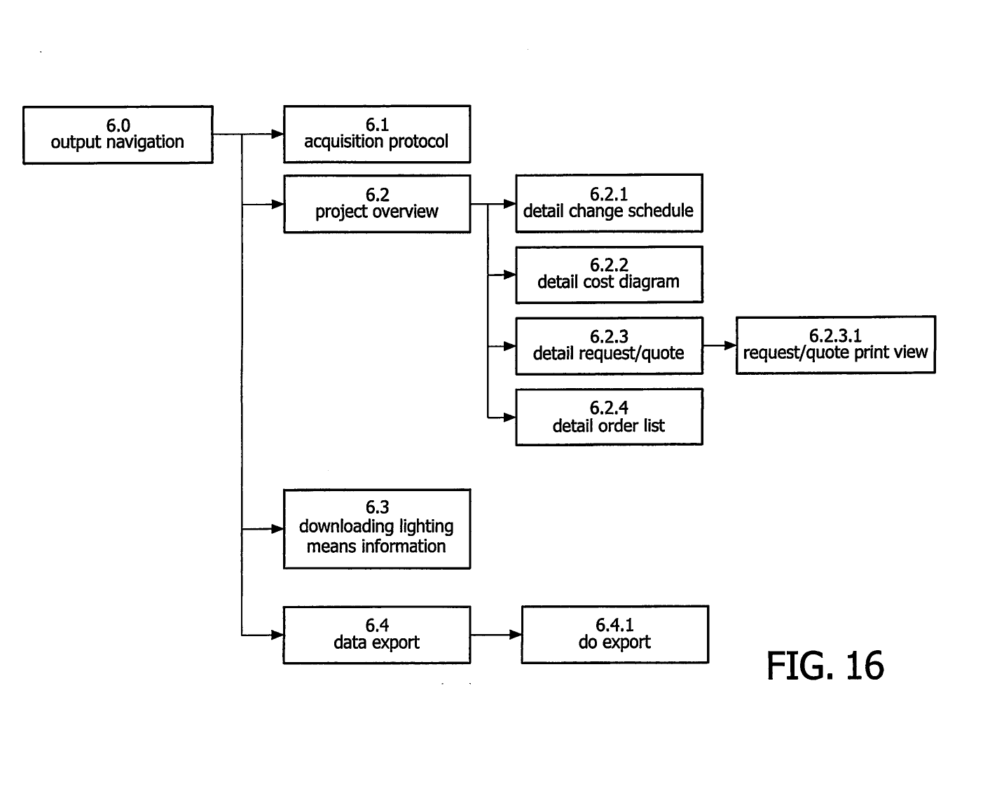

FIG. 16 shows a diagram with the structure of an output module;

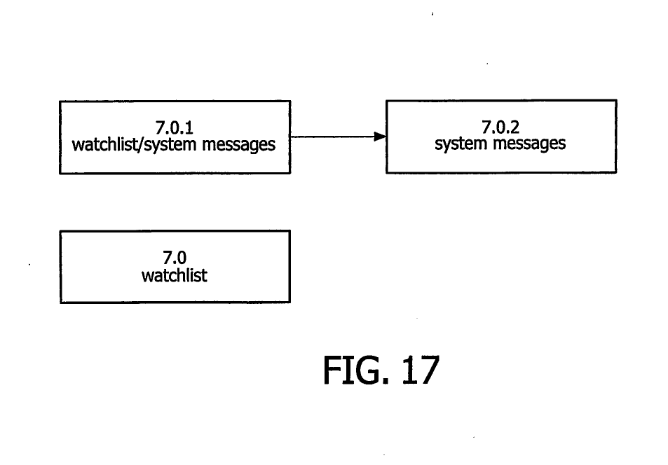

FIG. 17 shows a diagram of the structure of a messaging module;

FIG. 1 shows a symbolic representation of the main components of a system for planning of the operation of a number of lighting means. The system comprises, on the user side, a client computer 10 connected to a network 12. The system further comprises, on the server side, a server computer 14 with a database 16, which is connected to the same network 12.

Client computer 10 may be a conventional PC, generally including a processor, a memory and input/output devices (not shown). Computer 10 also includes a network interface. An operating system is running on computer 10 to accept input from input devices (e.g. keyboard, mouse) and to drive output devices (e.g. a monitor). In a preferred embodiment, client computer 10 may run the Windows operating system, and has installed a http client program (browser) for accessing html/xml content on network 12. In the preferred embodiment, the browser program can execute instructions in the JavaScript language. Possible programs are suitable versions of Netscape Navigator or Microsoft Internet Explorer.

Computer network 12 may be a LAN, WAN or any other type of computer network. A large number of computers may be connected to network 12. In a preferred embodiment, network 12 is the internet, and client computer 10 and server computer 14 communicate with each other using the TCP/IP protocol.

The server computer 14 maybe any type of computer, including a conventional PC. In the preferred embodiment, computer 12 includes a http server software for offering http services over network 12. Server computer 14 executes server side instructions in the PHP4 language. It will become apparent that the system will involve multiple users, and that numerical optimization calculations will be run on server 14. Therefore, it will be appreciated that generally a server computer 14 allowing fast execution of extensive calculations should be employed, possibly a multiprocessor system or even a cluster of several server computers.

FIG. 2 shows a symbolic representation of lighting means disposed in a facility 20. Facility 20 may be any type of facility disposed at a certain location, e.g. a industrial plant, an office building, a department store etc.

The lighting means within facility 20, are of several types. It may, for example, be assumed that facility 20 is a department store, where several discharge lamps are be disposed under the ceiling. These lighting means form a first group L1. Further, in a number of places in the department store, there are other lighting means. Conventional filament lamps may be disposed in several places which will here be referred to as a second group L2. Further, in display cases of the department store, halogen lamps may be used forming a third groups L3.

The system according to FIG. 1 is used to generate a schedule for the operation of the lighting means in the facility 20 and to execute this schedule. The aim is most cost-effective operation of facility 20 over a specified time period which may range, for example, from a few month to several years.

Within the system, which will be described in detail below, facility managers are able to generate a change schedule indicating at which point in time lighting means within the facility need to be exchanged.

There are further functionalities for the users, which will not be described on detail here. For example, facility managers can manage their personnel for exchanging the lighting means and can obtain quotes from wholesale merchants for needed parts. Wholesale merchants on the other hand can log onto the system and will receive requests for quote of lighting means and can decide to provide corresponding quotes.

The system is implemented as a computer program running on server computer 14 which in the preferred embodiment can be accessed over network 12 via the http protocol. A number of users access server computer 14 over network 12, preferably the internet, from their client computers. Server computer 14 stores all data entered in the associated database 16 and provides users with an interface for entering and retrieving information.

The service is only available for registered users. For each user, a number of projects can be stored. FIG. 3 shows a symbolic representation of the structure of a project “department_store_{—}01”, comprising a number of project parts P1a, P1b . . . . In each part, information about a number of groups of lighting means, disposed at a common location, are stored. In the project of FIG. 3, part P1a represents facility 20 from FIG. 2, with lighting means groups L1, L2 and L3 all disposed within facility 20.

As stated above, users access server computer 14 via a browser program. Server computer 14 dynamically generates html pages to be displayed on client computer 10. These pages have a number of control elements, such as links, buttons, drop-down-lists, input-fields etc. The pages are linked to each other, so that by using the control elements the user navigates between the pages.

The structure of these pages is shown in FIGS. 10-17 in diagram form. In these diagrams, each page is represented by a square. Where appropriate, several pages are depicted as an oval for a better overview. Arrows between pages designate possible navigation from one page to another page.

Data base 16 of server computer 14 stores user date, customer data, personnel data, page contents and access permissions. Data base 16 also stores project data input by the clients. Further, database 16 stores a large amount of lighting means data.

The lighting means data in data base 16 comprises information about a large variety of different lamps. For each lamp, a number of database fields are stored comprising information such as manufacturer, product family, manufacture label, electrical power, light colour, lifetime values etc. In the preferred embodiment, the following lifetime values are stored for each lamps: Lifetime_conv_{—}5: Total burning time with conventional power supply until 5% of lamps have failed, lifetime_conv_{—}10: Total burning time with conventional power supply until 10% of lamps have failed, lifetime_elect_{—}5: Total burning time with electronical power supply until 5% of lamps have failed, lifetime_elect_{—}10: Total burning time with electronical power supply until 10% of lamps have failed.

FIG. 10 shows the structure of a user login module. Initially, the user is presented a startpage 0.1. From the start page, a flash animation 0.9 can be selected which introduces the system to the user. From the start page, already registered users may access a login screen 0.2. Not previously registered users may register on a registration page 0.3, where they are shown the terms and conditions of service on a page 0.5. After successful registration (0.6), users can log in to the service. After the password is sent (0.8) successfully, a main frame 0.4 is shown.

FIG. 4 shows the main frame, as it is displayed by a client computer 10. The screen is divided into three areas as shown, a top area T, a left area L and a main area M. Pages can be loaded into each of these three areas.

Within top area T of main frame 0.4, a main navigation page 0.7 is loaded. The main navigation page allows the user to access the different modules “project”, “profile”, “customers”, “personnel”, “report”, and “watchlist”.

FIGS. 11-14 show the structure of the project module. Page 1.0 project navigation is loaded into the main frame at position L and serves for navigation within the module.

Within the module, each user can only access his own project. Users can choose to create new projects (1.1), edit existing projects (1.2) or show a change schedule (1.3).

FIG. 12 shows the structure of how a new project is created. Page 1.1 create new project is loaded at position M into the main frame. The page shows the user an overview of the projects already existing. For creation of new projects, the user can either select a corresponding wizard (1.1.1) or manual creation (1.1.2.). The user may also select to copy an existing project (1.1.3) after which he will be presented a warning (1.1.3.1) to exercise special caution and will than be able to edit the copied project (1.2).

In the following, creation of a new project will be explained as done by using the wizard (1.1.1). It is clear from FIG. 12 that this can also be done manually (1.1.2).

The wizard starts with a greeting page 1.1.1.1 at position M in the main frame. The wizard then guides the user through the creation process.

First, the user may input the project structure by creating and inputting project parts (1.1.1.2, 1.1.1.2.1) and project subparts (1.1.3, 1.1.3.1). There are a number of settings which can be individually adjusted for each project.

For each project, the following data is input by the user and stored in database 16: name of the project, customer the project is associated with, electricity tariff of the project per kWh, travel cost for the maintenance personnel to the project location, optimisation interval in weeks.

The optmisation interval is the time period, during which operation and maintenance of the lighting means will be optimised. The optimisation interval can be up to 10 years.

Each project can be associated with the name of a customer. The list of customers of a particular user is stored in database 16, where also further customer data may be stored.

Further, default values for certain settings of the project need to be input by the user: (a) average burning time of the lighting means per week, or alternatively, (b) number of business days per week and average burning time per business day, (c) time in minutes needed to change on individual lighting means out of the project, (d) disposal cost for a lighting means out of the project, (e) possibility to use energy saving lamps instead of general purpose lamps yes/no? (f) is an electronical or conventional power supply used?

It should be noted, that these values are default values only. In many cases the values will differ for different lamp groups within the same project. For example, the average burning time for different lamp groups may be quite different. However, these default values are used in a way that they are inherited down through the hierarchical structure from the project root down to its associated parts and subparts. Within this structure, the default settings may be overwritten. In cases where parts and subparts use the same settings as the entity they are associated with, the settings do not need to be repeatedly input by the user, but are already filled by inheritance. For example, if default parameter (a) is set to the average number of business hours per week, all groups created will initially have the same value (a). For most groups of lighting means this value will already be appropriate, because the lighting means are switched on only during business hours. For those groups, which need a different value, the default value (a) may be overwritten.

As will become apparent later, parameters (a)-(d) will be used directly in the optimisation. Value (e) allows the user to manually choose if general purpose lamps may be replaced by energy saving lamps. This decision can only be made by the user, because only he knows if the lamp may be replaced, due to geometry and appearance of a corresponding energy saving lamp. Value (f) will be used to determine the life time of fluorescent lamps, which is dependent on the type of power supply.

For each project part and project subpart, the user gives the name of the part/subpart and the association of a subpart to a project part, or to project root. Further, for each part/subpart parameters (a)-(f) are inherited from the associated entity, but may be overwritten by the user. For example, if the user chooses to create different project subparts for different areas of the facility, he may change the default value (c) for the time that is needed to exchange an individual lamp. As will be come apparent later, value (c) is again only used as a default value and may be overwritten for individual groups of lamps.

Page 1.1.1.1.1. acquisition protocol can be displayed and printed out by the user. The printed-out sheet serves as a template for the user to create an inventory of all lighting means in the facility to manage. In this way, the user collects the data later needed to supply the needed information for project parts/subparts and corresponding lamp groups.

On page 1.1.1.5, data of individual groups of lighting means is entered. For each group, the following parameters need to be provided by the user: name of the group, association with a project part/subpart, number of lighting means in the group.

Further, each group inherits parameters (a)-(f), and these parameters can be individually adjusted for each group if they differ from the project default values.

Further for each group, the user needs to specify the type of lighting means in the group. The corresponding pages are shown in FIG. 13.

Lighting means data as stored in database 16 is described above. Based on this information the user may specify the lighting means of a specific group on page 1.1.5.1. FIG. 5 shows an example of a corresponding page, where the user may select the search criteria manufacturer, type, power and colour from drop down lists. By using a button, “start search” the server computer 14 then searches database 16 for lamps matching these specification.

FIG. 6 shows an example of a corresponding search result (page 1.1.1.5.2), from which the user may select the type of the current lamp group by activating the corresponding “select” button.

Back now in FIG. 12, after inputting all project parts, subparts and corresponding lamp groups, the user is presented with page 1.1.1.6 where he can choose to finish his input or to go back an edit individual inputs (not shown).

Back in FIG. 11, from the project navigation page 1.0 the user may choose to edit a specific project. The corresponding structure is shown in FIG. 14. As becomes clear from FIG. 14, during editing of a project, the user may choose to edit or add project parts, subparts or lamp groups. Of course, the user may also edit the project data (e.g. project name, customer, electricity tariff, travel cost) or one of the default values of a project. The user may than choose to update the project (page 1.2.1). In the course of the update, depending on the project status, a re-calculation may become necessary. Also, it is possible that changes previously entered may affect the project status (e.g. if a new lighting means type is introduced, for which quotes need to be obtained). The user is warned about such a change, before preceding.

If the user chooses to edit a group, it is checked on page 1.2.3.1 if a newly input lighting means type can be identified within the database.

A page 1.2.4 choose status allows the user to choose the project status. The following stati are possible for a project:

1. Acquisition

The definition of areas, subareas and lamp groups is not yet finished.

2. Acquisition Finished

The acquisition has been completed, but quotes for lighting means are still needed, so that no change schedule can be generated yet.

3. Product Control Activated

In this status, no change schedule is to be generated yet. However, if changes in the database occur regarding lamps that have been selected by the user, the user wishes to receive corresponding system message.

4. Change Schedule Monitoring Activated

A change schedule has been generated and the system monitors upcoming change dates. For imminent change dates (x days before a change days) a notify message is generated, which will become visible in the watchlist described below. Additionally the user receives an electronic mail informing him of the upcoming change date.

5. Archive

The project has been finished and declared as archived. No further changes can be made, but project data can be viewed.

Users may input into the system data concerning their customers, for which they manage different facilities. Users who employ personnel to change lighting means may also manage their personnel resources within the system. The system may use this information to generate warnings if lighting means changes are scheduled at a time where not enough personnel is available. Further, the system may be used by users to obtain quotes for lighting means. Wholesale merchants may log into the system, receive requests for quotes and provide such quotes. These special features, although quite useful for the system, do not form part of the invention and will therefore not be further explained.

FIG. 15 shows the structure of a calculation module. Page 5.0 “calculation navigation” is loaded into the main frame at position L. Page 5.1 calculation overview is loaded into the main frame at position M. Page 5.1 calculation overview presents the user with a list of all projects and offers for each projects to run the optimisation or draw a calculation chart. Further, a number of options can be set on page 5.3 for each project, including the labour cost per hour, estimated rate of price increase (in percent p.a.), price for lighting means as previously obtained from a wholesale merchant, tolerance level for lifetime (5% or 10%), i.e. after which rate of failure to exchange lighting means, lifetime adjustment factor (Default 100%) and the choice if optimisation should comprise replacement of current lighting means with replacement lighting means.

The above mentioned lifetime adjustment factor allows the user to enter a factor adjusting the lifetime value for lighting means according to the specific environment of the managed facility. The lifetime values in the database are determined according to IEC standards in a standard environment. In an actual facility, however, different influences (ambient temperature, shocks/vibrations, supply voltage variation etc.) may influence the actual lifetime of lighting means operated in the facility. To account for these influences, users may enter a corresponding lifetime adjustment factor according to past experiences. If, for example, a user has observed that on the average lighting means in his facility fail about 10% earlier than according to the IEC standard value given for the specific lighting means, the user may enter a lifetime adjustment factor of 90%.

After the options have been set, the actual optimisation can be activated on page 1.3.1.1.

The aim of the optimisation is to archive minimum cost for a given time interval. Within this optimisation time interval the total costs are calculated as the sum of the cost of the individual groups in the project:
C_{Total}=C_{Group(1)}+C_{Group(2)}+ . . . +C_{Group(i)}

The costs for one group C_{Group} are calculated from the lighting means costs C_{Lamps}, travel costs C_{Travel}, personnel cost C_{Personnel}, disposal cost C_{Disposal} and energy cost C_{Energy}:
C_{Group}=C_{Lamps}+C_{Travel}+C_{Personnel}+C_{Disposal}+C_{Energy}.

The number of changes N_{Change} for the individual lamp group is calculated from the total burn time within the optimisation interval (calculated from parameters (a) or (b) by multiplying the average burn time per week with the number of weeks in the optimisation interval) and the appropriate lifetime value T_{Lifetime} of the lamp, considering the user's choices for a lifetime tolerance (5% or 10%) and, for fluorescent lamps, the information whether a conventional or an electronical power supply is used):
N_{Changes}=T_{Burn}/T_{Lifetime}

It should be noted that the above given value of N_{Changes} is only an approximation, which is only valid if lighting means are exchange directly after there burn time has exceeded the expected lifetime. This value of N_{changes} will therefor only serve as a starting value in the optimisation. In the course of the optimisation, which will be described later, different change schedules will be evaluated, and the total cost will then be re-calculated using the actual number of changes.

For each group, the lighting means cost is calculated from the unit price previously obtained from a wholesale merchant C_{Unit}, the number of lamps in the group N_{Lamps} and the number of changes in the optimisation interval N_{Changes}:
C_{Lamps}=N_{Lamps}*C_{Unit}*N_{Changes}.

The travel cost C_{Travel} is calculated from the cost for arrival and departure (2*C_{Route}). In case that on the same date the lighting means of two or more groups are exchanged, the travel cost is divided by the number of simultaneous changes at that date:
C_{Travel}=((C_{Route}*2)/Nₛₐₘₑ_{_{—}}_{change}_{_{—}}ₜᵢₘₑ₁)+((C_{Route}*2)/Nₛₐₘₑ_{_{—}}_{change}_{_{—}}ₜᵢₘₑ₂)+ . . . +((C_{Route}*2)/Nₛₐₘₑ_{_{—}}_{change}_{_{—}}_{time i})

The personnel cost per change Cₚₑᵣₛₒₙₙₑₗ_{_{—}}ₚₑᵣ_{_{—}}_{charge} for a specific group is calculated from parameter (c) of that group (time in minutes necessary to change one lamp), the number of lamps in the group, and the average personnel.cost per time unit.

The personnel cost is calculated from the personnel cost per change C_{Personnel}_{_{—}}ₚₑᵣ_{_{—}}_{change} and the number of changes in the optimisation interval N_{Changes}:
C_{Personnel}=C_{Personnel}_{_{—}}ₚₑᵣ_{_{—}}_{change}*N_{Changes}.

Disposal cost C_{Disposal} for each group is calculated from the number of lighting means in the group N_{Lamps}, disposal cost for lamp C_{Disposal}_{_{—}}ₗₐₘₚ and the number of changes in the time interval N_{Changes}:
C_{Disposal}=N_{Lamps}*C_{Disposal}_{_{—}}ₚₑᵣ_{_{—}}_{Lamp}*N_{Changes}.

Energy costs C_{Energy} are calculated from the known electricity tariff C_{kWh}, the total burn time T_{Burn} of the lighting means within the optimisation interval, the individual power consumption of each lighting means P_{Lamp} and the number of lighting means in the group N_{Lamps}:
C_{Energy}=C_{kWh}*T_{Burn}*P_{Lamp}*N_{Lamps}

In the course of the optimisation, a change schedule is generated which leads to a minimum of the above calculated total costs C_{Total} in the optimisation interval. The optimisation is done by using a numerical optimisation algorithm. In a preferred embodiment, the optimisation algorithm employed is a variant of the known “threshold accepting” method, which is a variant of a “simulated annealing” method. The general structure of the threshold accepting method is shown in FIG. 9. Optimisation starts out with a start configuration X₀, which in the present case is, for example, a change schedule for the current project as would be intuitively chosen, where the lighting means of each group are promptly exchanged after their burn time has exceeded the known lifetime for the given tolerance.

In the next step, the threshold T is determined as a numerical value.

Now, a new configuration Y is chosen, which is a slight change from the start configuration X. For the given optimisation problem, this means that in the new configuration Y change times are chosen slighting differently than in the present configuration X. Since change times for an individual group usually will not be allowed to be delayed (because the rate of failure of lighting means would then increase above the acceptable threshold), the changed configuration Y will generally have at least one change date for one lamp group which is earlier than in the start configuration X₀.

In the next step, the cost function C_{Total} is evaluated for both configurations X and Y. The difference is calculated and compared to the threshold T. If the difference is less than or equal to T, the new configuration Y becomes the present configuration. If not, the algorithm returns to the step before and chooses a new changed configuration Y.

Every time a cost difference between old and new configuration is found to be below threshold T, the value of T is lowered by a predetermined value x. The algorithm is repeated until no valid alternative (C_{Total}(Y)−C_{Total}(X)≦T) has been found in a predetermined number of iterations.

It should be noted that the above describe algorithm represents only an example of a possible implementation of the optimisation. Other methods are possible. Depending on the number of calculations that can be effected on server computer 14 within an acceptable response time, it may even be possible to calculate an absolute cost minimum by using a “brute force” approach (calculating all possible scenarios and choosing the configuration with minimum cost). A large number of further optimisation strategies and algorithms known to the skilled person may also be employed.

The above described optimisation only optimises the times in the optimisation interval, where whole groups of lighting means are charged. However, the user may alternatively select an extended optimisation where not only the change schedule itself is optimised, but the system is also considers to exchange lamps. Database 16 contains data on a large number of available lamps. During the extended optimisation, which is also effected according to FIG. 9 and the corresponding explanation above, alternative types of lighting means are determined from the database 16. The alternative means have to meet certain criteria: They have to fit into the same socket as the actual lighting means, need to provide an equivalent amount of light, need to have the same light colour (within a predetermined tolerance) etc. The alternative lighting means may differ in power consumption and lifetime values from the present lighting means (e.g. energy saving lamps vs. conventional filament lamps) and will therefore have an important influence on the value of the cost function C_{Total}. Replacement of lighting means by alternative types will be part of determining, in each iteration step of the optimisation, a new configuration Y.

Back in FIG. 15, the user can choose on page 5.1 calculation overview the option calculation chart. The corresponding page calculation chart 5.2 shows a chart which allows a facility manager to determine the cost within the optimisation interval. In the chart, cost is shown over time as an aggregated function, where the value at a certain time corresponds to the sum of all costs incurred up to that point in time.

Examples of such calculation charts are given in FIG. 8, which will later be described in detail with regard to optimisation examples.

For users who act as service providers providing maintenance service for lighting means at a monthly charge, the calculation chart may show a second curve, where the total revenues are shown. This allows such users to calculate an appropriate monthly charge.

FIG. 16 shows a report module. Here, the user can query the system for all types of information such as change plans, lighting means information, cost diagrams etc.

Page 6.0 output navigation is loaded into the main frame at position L and serves as navigation offering the user the choice of page 6.1 acquisition protocol, 6.2 project overview, 6.3 download lamp information, and 6.4 data export.

Page 6.1 acquisition protocol prints out an acquisition form which can be used to gather information about all lighting means in the facility.

Page 6.2. project overview is loaded into the main frame at position M. The page shows all projects of the current user and provides options regarding these projects.

FIG. 7 shows an example of such a project overview. For each project, the next scheduled change is shown. The detailed change schedule is shown after selection of corresponding link in page 6.2.1. Another link leads to page 6.2.2 showing the user the cost diagram (FIG. 8). A further link leads to page 6.2.3 giving details of quotes obtained from wholesale merchants for the lighting means in the project, which can be printed out on page 6.2.3.1. The order list of lighting means for the project can be viewed on page 6.2.4.

Page 6.3 download lighting means information can be accessed from page 6.0 output navigation. On this page, a booklet with available lighting means can be downloaded by the user.

Another option on page 6.0 output navigation is data export. The corresponding page 6.4 allows the user to export his requests for quote, obtained quotes and detail order list. Possible export formats are csv-files, which can be imported in Microsoft Exel, Microsoft Access or other database programs, or xml-files, which will in future be supported by a large number of programs.

FIG. 17 shows a watchlist module. Page 7.0 watchlist is accessible from the main navigation page 1.0 (see FIG. 10). Page 7.0 watchlist shows all projects and corresponding next change dates. Additionally, in a separate group all projects are shown in which the change schedule comprises a change date within the next 30 days.

Page 7.0.1 watchlist/system messages is loaded into the main frame at position M directly after login of a registered user. This page shows a list of all project with change dates in the next 30 days. Also, system messages relevant to the user are shown.

Next, an example for managing facility 20 of FIG. 2 with the system will be given. It should be noted, that this choice of an extremely simple example with only three groups has been made for illustration purposes only. In practise, projects will involve a far larger number of groups. For the simple structure of facility 20, it is of course unnecessary to divide the project into parts and subparts. However, for illustration purposes the project structure given in FIG. 3 was chosen.

The relevant user is the facility manager of facility 20. This user will use his client computer 10 to access server computer 14 with a html client program, for example Microsoft Internet Explorer. After connecting to the server, he will first go through registration and login procedure (FIG. 10). From the main navigation page 0.7, he will than choose “project navigation”, and from corresponding page 1.0 the option “create new project” to enter his project.

The user will than proceed with project creation (FIG. 12) by entering the project structure according by FIG. 3 with project part P1a and lamp groups L1, L2 and L3. The user will enter default parameters (a)-(f), and will overwrite, where necessary, these values for the individual lamp groups. The user will than change the status of the project from 1 (acquisition) to 2 (acquisition completed).

In the next step, the user will place requests for quotes to obtain quotes for the lighting means used in the project from wholesale merchants active in the system. After obtaining the quotes, the user will select on page 1.0 project navigation the option “show change schedule” for the project, enter his preferences on page 1.3.1 “set preferences” and than cause the system to start optimisation.

The System will than take the entered data to determine an optimal change schedule as explained above. For the example of facility 20, the following change schedule may be the optimum determined by the server:

| Project: DepartmentStore_01 | | |
|---|---|---|
| Part: P1a | | |
| Group L1 | | |
| Group L2 | | |
| Group L3 | | |
| *No Alternatives* | | |
| Change Schedule: | | |
| Start: | 1.1.2004 | |
| | 20.3.2004 | change L2 |
| | 1.5.2004 | change L1, L2, L3 |
| | 20.8.2004 | change L2 |
| | . . . | |

The change schedule in this example was determined without considering alternative types of lighting means. The change schedule starts on Jan. 1, 2004. After about 80 days, the filament lamps in group L2 need to be exchanged. Normally, the lamps of group L2 would have to be exchanged after another 80 days for a second time. Instead, the optimum change schedule places the changes of all three lamp groups together before this date on 01.05.2004. Although in this way the lighting means in group L2 are exchanged before they reach the actual end of their expected lifetime, the total cost is still lower. This is, because travel cost C_{Travel} needs to be accounted for only once on Jan. 5, 2004, instead of multiple times if the lamps groups were exchange on different days.

FIG. 8 shows the corresponding cost chart with the accumulated total cost C_{Total} (shown as a solid line) over time t. Between the change dates, the cost increases linearly because of power consumption. At the first change date, only group L2 is changed and therefore there is a comparatively small step, corresponding to the cost incurred. On the second change date, the step is considerably larger because all three groups L1, L2, and L3 are exchanged.

In an alternative example for facility 20, the user has chosen that the system should consider alternative lighting means types. An example for an optimum change schedule would be the following:

| Project: DepartmentStore_01 | | |
|---|---|---|
| Part: P1a | | |
| Group L1 | | |
| Group L2 | | |
| Group L3 | | |
| *Consider Alternatives* | | |
| Change Schedule: | | |
| Start: | 1.1.2004 | |
| | 20.3.2004 | change L2, replace with Philips |
| Master PL | | |
| | | 18 W |
| | 1.5.2004 | change L1, L2, L3 |
| | 1.10.2004 | change L1, L2, L3 |
| | . . . | |

When considering the above change schedules with and without alternatives in comparison, it becomes clear that the first change event on Mar. 20, 2004 for lamp group L2 is identical. However, in the second case the filament lamps of group L2 are replaced by energy-saving lamps which correspond in light colour, socket type etc. to the filament lamps of group L2. These energy-saving lamps have lower electrical power consumption and longer lifetime than conventional filament lamps.

However, also in the second change schedule all three groups L1, L2 and L3 are exchanged together on, although here again lifetime of lamp group L2 has not been reached. However, by combining the change of all three groups L1, L2 and L3 on 01.05.2004, the change intervals of the three groups are now nearly identical, so that all following changes can be effected for all three groups at the same time, thus saving a large amount on cost for all subsequent changes.

FIG. 8 shows the associated cost chart as a dotted line. At the first change event, lighting means of group L2 are replaced by energy saving lamps. Note that the cost step at this point is considerably larger than the corresponding step in FIG. 18 because of the higher cost of energy saving lamps. However, after the first change event, the further increase between change events, which is due to power consumption, is less because of the lower power consumption of the newly installed energy saving lamps. At the second change event, the cost step is considerable because groups L1, L2 and L3 are exchanged simultaneously. However, here again the travel cost C_{Travel} are incurred only once.

It can be seen from FIG. 8, that the alternative change schedule leads to lower overall cost in the shown time interval.

After the user has thus generated and viewed the appropriate change schedule, he can log out of the system. The user now has a complete overview of the necessary maintenance events in the optimisation interval and can make corresponding arrangements. The user also has a detailed forecast of cast for this time interval.

If the user subsequently logs into the system, he will be shown page 7.0.1 with his watchlist and system messages. The watchlist will show in which project a change event is due in the next thirty days. Also, independently of the user login into the system, he will regularly receive notify messages via electronic mail by the system to inform him of upcoming change events.

If the user operates facility 20 according to the change schedule, the total cost incurred in the optimisation interval will be at a minimum.

It should be noted, that the above describe system represents a preferred embodiment of the invention. The skilled person will appreciate that the invention can be practised in different ways.

A possible modification involves that, instead of only generating and displaying a change schedule, the system actively monitors the change status of lighting means. Effected maintenance events (change of lighting means) are entered into the system. It may be possible that despite the system's recommendation, a change is effected at an earlier or a later date. After entering the actual change date, the system may re-start optimisation to check if the different change time leads to recommendation of a different change schedule with different subsequent change times.

1. System for automatic planing of the operation of a number of lighting means, said system comprising input and storage means configured for input and storage of a plurality of parameters for a plurality of groups comprising lighting means of the same type in the same location, where the parameters of each group comprise at least: the number of lighting means in the group, the type of lighting means, and/or a price and a value for a lifetime of the lighting means, an operating time of the lighting means, a first outlay parameter representative of the outlay for preparation for a change of lighting means at said location, and a second outlay parameter representative of the outlay for changing of the lighting means, said system further comprising computing means configured to calculate a change schedule with change times for changing of all of the lighting means of individual groups, where said change schedule is calculated such that in a given time interval the total cost for all groups is minimized, where said computing means are configured such that for each group the group costs for replacement of lighting means within said time interval are calculated, and where in case of identical change times for different groups the first outlay parameter is accounted for only once.

2. System according to claim 1, said system further comprising database means configured to store a number of lighting means types, where for each lighting means type at least a price and a value of a lifetime for lighting means of the lighting means type are stored.

3. System according to claim 2, said system further comprising substitution means for determining for a present lighting means type of at least one of said groups at least one alternative lighting means type, where said computing means are configured to calculate said change schedule such that said schedule comprises an exchange of said present lighting means type by said alternative type if the total cost for said given time interval is lower than without the exchange.

4. System according to claim 3, where said database means are configured to store for each lighting means type a value for power consumption, and where said computing means are configured to calculate for said given time interval the total cost, accounting for the cost of power consumption.

5. System according to claim 1, where storage means are provided for storing a number of projects, where each project comprises a plurality of groups of lighting means disposed at one location.

6. System according to claim 5, where said input and storage means are configured to query the user for a plurality of default parameters, where for each lighting means group in the project said default parameters are copied, but may be overwritten by the user.

7. System according to claim 1, where said input and storage means comprise a network interface, said system further comprising output means to output at least said time schedule over said network interface.

8. System according to claim 1, said system further comprising storage means for storing said change schedule, and messaging means for automatically sending messages reminding of a change of lighting means.

9. Method for planning the operation of a number of lighting means, where a plurality of parameters are stored for a plurality of groups comprising similar lighting means at a common location, where the parameters of each group comprise at least: the number of lighting means in the group, the type of lighting means, and/or a price and a value for a lifetime of the lighting means, an operating time of the lighting means, a first outlay parameter representative of a preparation outlay for changing of the lighting means, and a second outlay parameter representative of the outlay for changing of the lighting means, where a change schedule with changing times for change of all of the lighting means of individual groups is calculated, such that in a given time interval the total cost for all groups is minimized, where for each group the group costs for change and replacement of lighting means within said time interval are calculated, and where in case of identical change times for different groups the first outlay parameter is accounted for only once.

10. Computer program for planning the operation of a plurality of lighting means with an input and storage routine for input and storage of parameters of a plurality of groups of similar lighting means at a location, where the parameters of each group comprise at least: the number of lighting means in the group, a type of lighting means, and/or a price and a value for a lifetime of the lighting means, an operating time of the lighting means, a first outlay parameter representative of a preparation outlay for changing of the lighting means, and a second outlay parameter representative of the outlay for changing the lighting means, and a computing routine for determining a change schedule with change times for changing of all of the lighting means of individual groups, where the computing routine calculates the change schedule such that in a given time interval the total cost of all groups is minimized, where for each group the group costs for change and replacement of lighting means within said time interval are calculated, and where in case of identical change times for different groups the first outlay parameter is accounted for only once.
